(19) United States
(12) Patent Application Publication
(10) Pub. No.: US 2012/0026409 A1
(43) Pub. Date: Feb. 2, 2012

(54) Electronic Device and Remote-Control Method

(76) Inventors: Yasukazu Higuchi, Kawasaki-shi (JP); Masaaki Kikuchi, Akishima-shi (JP); Yoshihiro Ohmori, Ome-shi (JP); Toyokazu Itakura, Kawasaki-shi (JP); Yuuichi Togashi, Tokyo (JP)

(21) Appl. No.: 13/082,209

(22) Filed: Apr. 7, 2011

(30) Foreign Application Priority Data
Jul. 27, 2010 (JP) 2010-168526

(51) Int. Cl. H04N 5/44

(52) U.S. Cl. 348/734; 348/E05.096

(57) ABSTRACT

According to one embodiment, an electronic device searches video devices connected to a network. The electronic device transmits a predetermined command to an identification-target video device via the network in order to make a user confirm the identification-target video device. The identification-target video device is a device selected by the user from the searched video devices, the predetermined command causing the identification-target video device to execute a predetermined operation. The electronic device transmits a command to a operation-target video device via the network in order to remote-control the operation-target video device. The operation-target video device is a device selected by the user from the searched video devices, the command causing the operation-target video device to execute an operation designated by the user.

### CROSS-REFERENCE TO RELATED APPLICATIONS

This application is based upon and claims the benefit of priority from Japanese Patent Application No. 2010-168526, filed Jul. 27, 2010; the entire contents of which are incorporated herein by reference.

### FIELD

Embodiments described herein relate generally to an electronic device which remote-controls a video device, and a remote-control method which is applied to the electronic device.

### BACKGROUND

In general, in a video device such as a TV or a video recorder, the operation of the video device is controlled by using a remote-controller which is attached to the video device.

Recently, techniques have been developed for executing, for example, the setup of programmed recording in a video device from a personal computer via the Internet. In addition, there are known techniques for transmitting various remote-control codes for operating the video device from a terminal, such as a personal computer, to the video device via a network.

However, it is possible that multiple video devices are connected to a household network. In this case, even if a device name list of devices, which can be operated, is merely displayed on the screen of a terminal functioning as a remote-controller, it is difficult for a user to understand which of the household video devices is an actual target of operation.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary block diagram illustrating the structures of an electronic device according to an embodiment and each of video devices which are remote-controlled by the electronic device;

FIG. 2 is an exemplary flowchart illustrating an example of the procedure of a remote-control operation including a device identification process, which is executed by the electronic device of the embodiment;

FIG. 3 is an exemplary block diagram illustrating a structure example of hardware and software of the electronic device of the embodiment;

FIG. 4 is an exemplary view illustrating an example of a device registration screen which is displayed on the display of the electronic device of the embodiment;

FIG. 5 is an exemplary view illustrating an example of a device confirmation screen which is displayed on the display of the electronic device of the embodiment;

FIG. 6 is an exemplary view illustrating another example of the device confirmation screen which is displayed on the display of the electronic device of the embodiment; and

FIG. 7 is an exemplary view illustrating still another example of the device confirmation screen which is displayed on the display of the electronic device of the embodiment.

### DETAILED DESCRIPTION

Various embodiments will be described hereinafter with reference to the accompanying drawings.

In general, according to one embodiment, an electronic device comprises a video device search module, a first command transmitter and a second command transmitter. The video device search module is configured to search video devices connected to a network. The first command transmitter is configured to transmit a predetermined command to an identification-target video device via the network in order to make a user confirm the identification-target video device. The identification-target video device is a device selected by the user from the searched video devices, the predetermined command causing the identification-target video device to execute a predetermined operation. The second command transmitter is configured to transmit a command to a operation-target video device via the network in order to remote-control the operation-target video device. The operation-target video device is a device selected by the user from the searched video devices, the command causing the operation-target video device to execute an operation designated by the user.

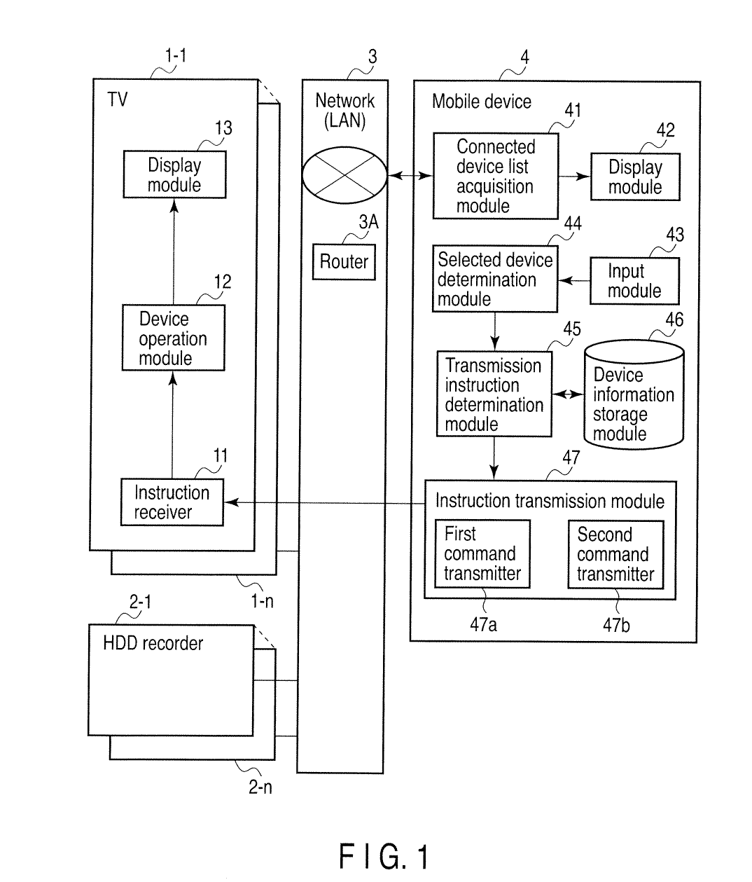

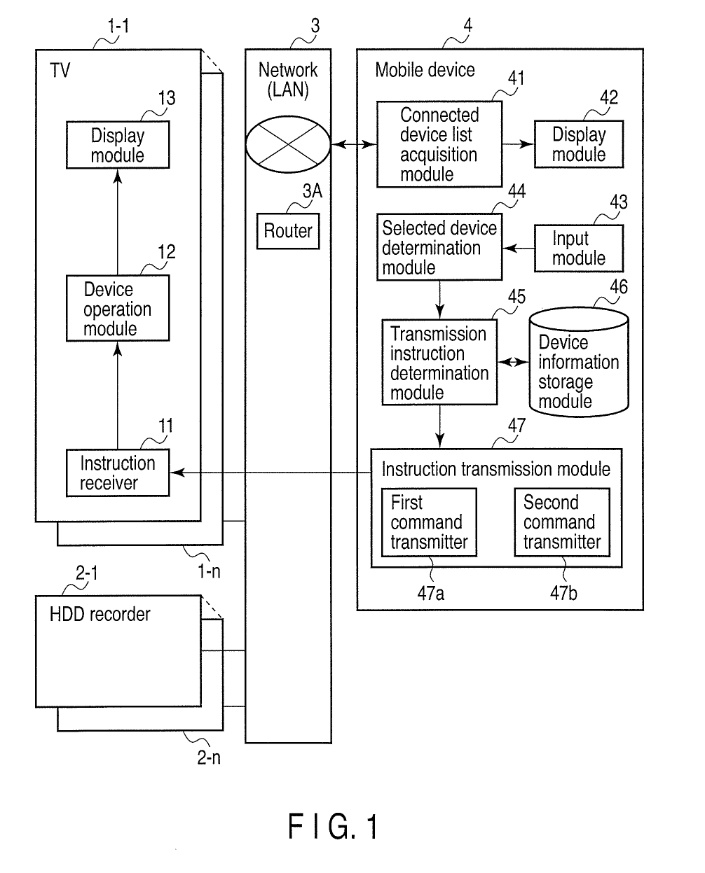

To begin with, referring to FIG. 1, a description is given of a system configuration of a home network comprising an electronic device according to an embodiment. This electronic device is configured to remote-control, with use of a unified interface, each of video devices connected to a network 3 such as a household local area network (LAN). This electronic device is realized by a mobile device (mobile terminal) 4 such as a PDA or a mobile phone. The mobile device (mobile terminal) 4 functions as an IP remote-controller for remote-controlling the respective video devices on the network 3 via the network 3.

A plurality of video devices, such as a TV and a HDD recorder, can be connected to the network 3. The case is now assumed in which a plurality of TVs 1-1 to 1-n and a plurality of HDD recorders (video recorders) 2-1 to 2-n are connected to the network 3.

The network 3 is, for example, a local area network such as a wired LAN or a wireless LAN. The network 3 may comprise a router 3A such as a broadband router. In this case, the TVs 1-1 to 1-n and HDD recorders (video recorders) 2-1 to 2-n may be connected to, for example, LAN-side ports of the router 3A. In addition, the mobile device 4 may be wirelessly connected to the router 3A via a wireless LAN. The WAN-side port of the router 3A may be connected to, for example, the Internet via a public network.

Each of the TVs 1-1 to 1-n and HDD recorders 2-1 to 2-n has a function of interpreting and executing a command which is received from the mobile device 4 via the network 3. Using a NetBIOS, for example, the mobile device 4 can search video devices connected to the network 3, and can set each searched video device to be a target of remote-control. The mobile device 4, in place of the remote-controller attached to the TV or HDD recorder, can remote-control, for example, the operational environment relating to a video process of each video device.

A remote-control operation screen is displayed on a display of the mobile device 4. By pressing buttons on the remote-control operation screen, the user can execute, for the video device (operation-target video device) that is the target of operation, various remote-control operations such as a change of the channel of a to-be-received broadcast signal, a volume control, an instruction to start and stop playback, an instruction to start and stop recording, and an instruction for programmed recording.

In this case, a plurality of kinds of remote-control operation screens associated with the kinds of operation-target video devices such as a TV and a HDD recorder may be prepared. A remote-control operation screen corresponding to the kind of operation-target video device, which has been selected by the user, may be displayed on the display of the mobile device 4.

For example, the remote-control operation screen for remote-controlling the TV may comprise a plurality of operation screens. In this case, these plural operation screens are associated with different ones of the buttons provided on the remote-controller attached to the TV. In other words, different buttons are allocated to the respective operation screens. The user can change, for example, by a tap operation, the operation screen which is displayed on the display of the mobile device 4. While changing the remote-control operation screen which is displayed on the display of the mobile device 4, the user presses a target button, thus being able to transmit a command (key code) corresponding to the pressed button to the operation-target video device, for instance, the TV 1-1. Similarly, the remote-control operation screen for remote-controlling the HDD recorder may comprise a plurality of operation screens.

In addition, the mobile device 4 can also control a playback start positions of recorded video data, by using a bookmark called “tag list”. The tag list comprises a plurality of tags (bookmarks) designating a plurality of playback start positions in the recorded video data. The tag list may be downloaded, for example, from a server on the Internet. Tags in the downloaded tag list are displayed on the display of the mobile device 4. When a certain tag has been selected by the user, the mobile device 4 transmits a skip command to the operation-target video device. The skip command indicates, for example, a skip width (skip time) from the present position of video data to a playback start position which is associated with the selected tag.

Further, the mobile device 4 has a device identification function for making the user confirm the operation-target video device. The device identification function is a function for calling (locating) the operation-target video device by an operation from the mobile device 4.

The display of the mobile device 4 displays a list of the device names of searched video devices on the network 3, and icons corresponding to the video devices. The user can select the operation-target device from, for example, the list of device names. However, in some cases, it is difficult for the user to understand the correspondency between the list of device names or icons, on one hand, and actual video devices in the home, on the other. In order to make the user confirm the video device (identification-target video device) that is the target of identification, which has been selected by the user from the searched video devices, the device identification function transmits via the network 3 to the identification-target video device a command (device confirmation operation command) for causing the identification-target video device to execute a preset predetermined operation. Since the identification-target video device, which has received the device confirmation operation command, executes an operation corresponding to the device confirmation operation command, some variation which can be recognized by the user occurs on the identification-target video device side. Thereby, it is possible to make the user confirm which of the devices in the home the identification-target video device corresponds to.

As the device confirmation operation command, use can be made of, for instance, (1) a command to change (increase or decrease) the sound volume in minute steps, (2) a command to repeatedly and alternately change the channel between two channels, (3) a command to produce alarm sound, and (4) a command to display an alarm on the front panel (operation panel) of the video device.

In the present embodiment, at least one predetermined command, which is pre-selected from commands for controlling the operational environment relating to the video process, is used as the device confirmation operation command. For example, as the device confirmation command, use may be made of an existing command which is commonly usable in various video devices (e.g. a command for a channel change, a command for volume increase/decrease, or a command for an input video change). The existing command which is commonly usable in various video devices means a command to execute a common operation between a plurality of predetermined video devices, this command being of commands for controlling the operational environment relating to the video process. Alternatively, as the device confirmation command, use may be made of an existing command that is unique to each device (e.g. a command to unload recording media of a recorder, a command to produce alarm sound, a command to execute two-screen display of a TV, or a command to change the display size of a TV).

In the case of using, as the device confirmation command, the existing command which is commonly usable in various video devices, one or more existing commands may be transmitted. In the case of using, as the device confirmation command, the existing command which is unique to each device, it is possible to transmit, as the device confirmation command, unique commands (unique command items) in which existing commands unique to a plurality of devices corresponding to the mobile device 4 are combined, with at least one unique existing command being used with respect to each device. In other words, it is possible to transmit, as the device confirmation command, a plurality of unique command items corresponding to a plurality of predetermined video devices. The unique command items comprise at least one unique command item for each of the plurality of predetermined video devices. These unique command items are of the commands for controlling the operational environment relating to the video process.

By using, as the device confirmation operation command, the existing command for controlling the operational environment relating to the video process, it becomes possible to realize the device identification function at a lower cost than in the case where special commands for device confirmation are prepared. Moreover, the device identification function can be applied to various existing video devices which do not support special commands for device confirmation.

For example, in the TV, when a channel change command is used as the device confirmation operation command, the channel received by a tuner in the TV is alternately changed between, e.g. two channels. Thereby, the video data, which is currently being viewed, is alternately switched, for example, between the video data of the current channel and the video data of another specific channel. Furthermore, at the time of the channel switching, as in the case where the channel number on the remote-controller is pressed, a channel number, to which the present channel number is to be changed, is displayed on the screen of the TV. Thus, when the channel change command is used as the device confirmation operation command, the channel number, which is displayed on the screen of the TV, is also alternately switched between the two channel numbers. As regards the HDD recorder, the channel number, which is displayed on the operation panel of the HDD recorder, is alternately switched between two channel numbers. In the meantime, the HDD recorder may operate the TV via an interface such as HDMI, thereby displaying the channel number on the screen of the TV.

In usual cases, during recording, even if another channel number is pressed by the operation of the remote-controller, the channel number is not changed. Thus, it can be said that the channel change command is a command which causes no problem with the operation of the video device.

For example, when a command to change the sound volume is used as the device confirmation operation command, the volume level is displayed on the screen of the TV and the display of the volume level is varied. In the HDD recorder, the volume level display on the operation panel thereof is varied.

Two or more kinds of existing commands may be combined and used as the device confirmation operation command. For example, the command to alternately switch the channel between two channels may be transmitted during a starting period in the device identification process period, and thereafter the command to repeat the increase/decrease of the volume may be transmitted.

Alternatively, commands, in which existing commands unique to a plurality of predetermined video devices corresponding to the mobile device 4 are combined with respect to these video devices, may be used as the device confirmation operation command. In this case, the device confirmation operation command may comprise at least one unique existing command with respect to each of the plurality of predetermined video devices which can be set to be targets of control by the mobile device 4.

For example, when the mobile device 4 is adaptive to both the TV and DVD recorder, commands, in which a command to execute 2-screen display or multi-screen display, which is a function unique to the TV, and a command to unload recording media, which is a function unique to the DVD recorder, are combined, may be used as the device confirmation command. In this case, if the operation-target device is the TV, the display of the TV is changed to 2-screen display or multi-screen display. If the operation-target device is the DVD recorder, the media tray is ejected to unload recording media. In each device which has received a plurality of device unique commands as the device confirmation operation command, the device executes the operation corresponding to the command unique to the device itself with respect to the command unique to the device itself, but the device does not respond to a unique device command which does not correspond to the device itself.

Next, the structures of each video device and mobile device 4 are described.

All video devices have functions corresponding to IP remote-control. In this description, the TV 1-1 is taken as an example, and the structure for supporting the IP remote-control is described. The TV 1-1 comprises an instruction receiver 11, a device operation module 12 and a display module 13.

The instruction receiver 11 receives various commands (instructions) from the mobile device 4 via the network 3. The device operation module 12 interprets a command which is received by the instruction receiver 11, and executes the operation designated by the command (e.g. channel change, volume control, playback start/stop, recording start/stop, programmed recording, etc.). The display module 13 displays video, graphics, characters, etc. on the screen of the display of the TV 1-1.

In the meantime, the device operation module 12 can also interpret and execute a command which is sent from a remote-controller which is attached to the TV 1-1. In other words, the TV 1-1 can be remote-controlled from the remote-controller attached to the TV 1-1, and can also be remote-controlled from the mobile device 4. Similarly, each of the other video devices can be remote-controlled from the remote-controller attached to the video device, and can also be remote-controlled from the mobile device 4.

The mobile device 4 comprises a connected device list acquisition module 41, a display module 42, an input module 43, a selected device determination module 44, a transmission instruction determination module 45, a device information storage module 46, and an instruction transmitter 47.

The connected device list acquisition module 41 is a device search module which searches video devices connected to the network 3 and acquires information unique to each video device connected to the network 3 (e.g. device name, user name, password, IP address, etc.) from each video device. For example, the NetBIOS may be used for the search of video devices. It should suffice if the device search is executed only once, when the mobile device 4 (IP remote-controller) is first connected to the network 3, or when a new video device or mobile device 4 (IP remote-controller) is additionally provided. To start with, the connected device list acquisition module 41 of the mobile device 4 searches video devices, such as a TV and an HDD recorder, which are connected to the network 3, by using the NetBIOS. The NetBIOS is unable to access devices beyond sub-networks, but can search devices connected to the same local area network by using broadcast. This function is one of NetBIOS name services. By using the NetBIOS, the IP address of each video device can also be acquired. The mobile device 4 (IP remote-controller) stores the acquired IP address in association with the device name, etc. Thereby, after the IP address is acquired, the mobile device 4 (IP remote-controller) can be connected to each device by using the IP address.

The display module 42 displays a list of device names of the video devices, which have been searched by the connected device list acquisition module 41, as a device list on the display of the mobile device 4. By operating the input module 43, the user can select an identification-target video device or an operation-target video device from the devices within the device list. Specifically, the selected device determination module 44 determines the video device that is the identification target or operation target, in accordance with the operation of the input module 43 by the user. The transmission instruction determination module 45 determines a command (instruction) which is to be transmitted to the identification-target video device or the operation-target video device.

At the time of the identification process, the transmission instruction determination module 45 automatically selects one or more predetermined specific commands for device identification, for example, from commands for remote-control which are stored in the device information storage module 46, and sends the selected one or more commands to the instruction transmitter 47. In an ordinary remote-control process, a command corresponding to a button on the operation screen, which has been selected by the user, is determined by the transmission instruction determination module 45 to be a command (instruction) which is to be transmitted to the operation-target video device, and the command is sent to the instruction transmitter 47.

The instruction transmitter 47 transmits the command, which has been received from the transmission instruction determination module 45, to the IP address of the identification-target video device or to the IP address of the operation-target video device.

The transmission instruction determination module 45 cooperates with the instruction transmitter 47, and functions as two command transmitters, namely a first command transmitter 47a and a second command transmitter 47b. The first command transmitter 47a transmits a predetermined command (device confirmation operation command), which causes the identification-target video device selected by the user to execute a predetermined operation, to the identification-target video device via the network 3. In order to remote-control the operation-target video device selected by the user, the second command transmitter 47b transmits a command, which causes the operation-target video device to execute an operation designated by the user, to the operation-target device via the network 3.

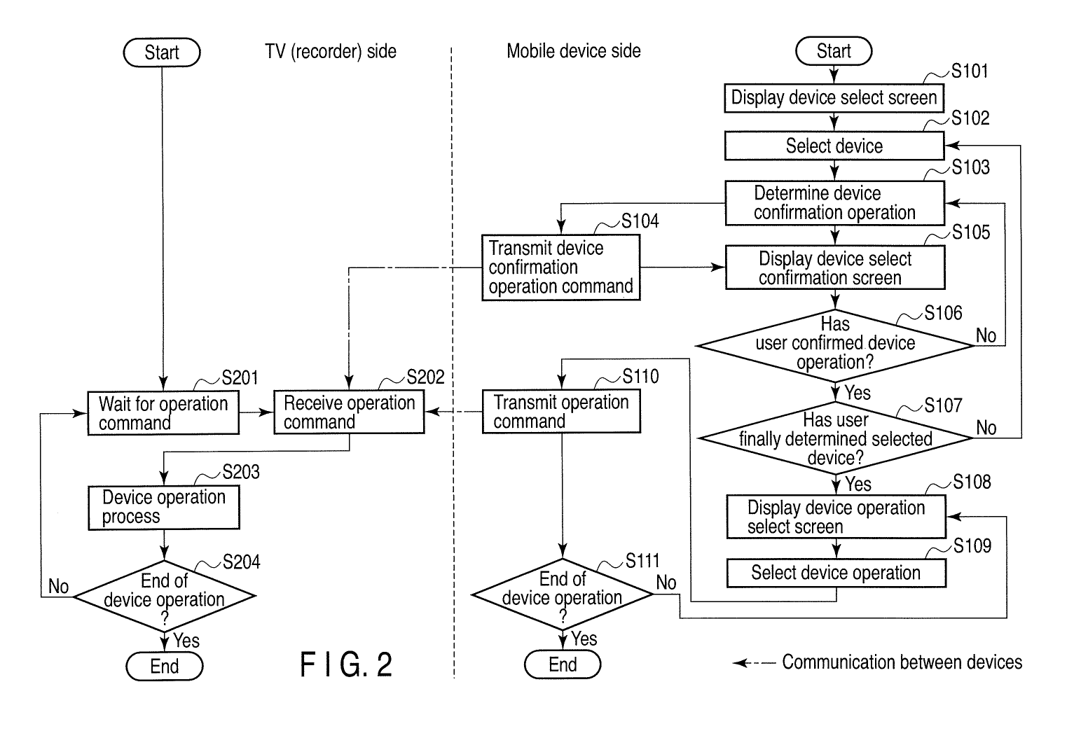

Next, referring to a flowchart of FIG. 2, a description is given of an example of the procedure of a remote-control operation comprising a device identification process, which is executed by the mobile device 4.

To start with, the mobile device 4 displays on the display a device select screen showing a list (e.g. device name list) of searched video devices on the network 3 (step S101). The mobile device 4 selects one video device from the list of video devices in accordance with an operation of the input module 43 by the user (step S102). Then, the mobile device 4 determines whether the user has executed a “device identification operation” (device confirmation operation) (step S103). In this context, the “device identification operation” (device confirmation operation) means an operation for requesting execution of a device identification process for the selected device. For example, when the device name of one video device displayed on the device select screen is continuously pressed for a predetermined time or more (“long-time press”) or when an “identification” button on the screen has been pressed by the user, it may be determined that the “device identification operation” (device confirmation operation) has been executed.

When the “device identification operation” (device confirmation operation) has been executed, that is, when the identification-target video device has been selected by the user from the list of searched video devices displayed on the display, the mobile device 4 transmits a device confirmation operation command via the network 3 to the currently selected video device (identification-target video device) (step S104). As the device confirmation operation command, used is made of a predetermined command pre-selected from the commands for controlling the operational environment relating to the video process.

The video device waits for an operation command (step S201). Upon receiving a command from the network 3 (step S202), the video device executes a device operation process for executing an operation corresponding to the received command (step S203). There is a case in which the device operation is executed by a plurality of device operation processes according to a series of commands. In this case, until the device operation is completed (NO in step S204), the video device returns to the wait state for an operation command, each time the device operation process corresponding to one command has been executed (step S201).

After transmitting the device confirmation operation command, the mobile device 4 displays on the display of the mobile device 4 a device select confirmation screen for inquiring of the user as to whether the user has successfully confirmed the device to which the currently selected device corresponds (step S105). A “confirmation” button for notifying the completion of confirmation may be displayed on the device select confirmation screen. The mobile device 4 may repeatedly transmit the device confirmation operation command, until the “confirmation” button is pressed by the user, that is, until the user successfully confirm which device the currently selected device corresponds to.

When the “confirmation” button has been pressed by the user (YES in step S106), the mobile device 4 determines that the user has confirmed which device the currently selected device corresponds to. Then, the mobile device 4 determines whether a user operation has been executed to finally determine the currently selected device to be the operation-target device (step S107).

If the currently selected device has not been finally determined to be the operation-target device (NO in step S107), the mobile device 4 executes once again the process for selecting the identification-target video device or the process for transmitting the device confirmation operation command to the identification-target video device.

If the currently selected device has been finally determined to be the operation-target device (YES in step S107), the mobile device 4 displays the above-described remote-control operation screen as a device operation select screen on the display of the mobile device 4 (step S108). If a button on the device operation select screen has been pressed by the user, the mobile device 4 selects a device operation corresponding to the pressed button, and determines a command corresponding to the selected device operation to be a transmission operation command (step S109). The mobile device 4 transmits the determined transmission operation command to the IP address of the operation-target device (step S110). The process of steps S108 to S110 is repeatedly executed until the end of the device operation (NO in step S111).

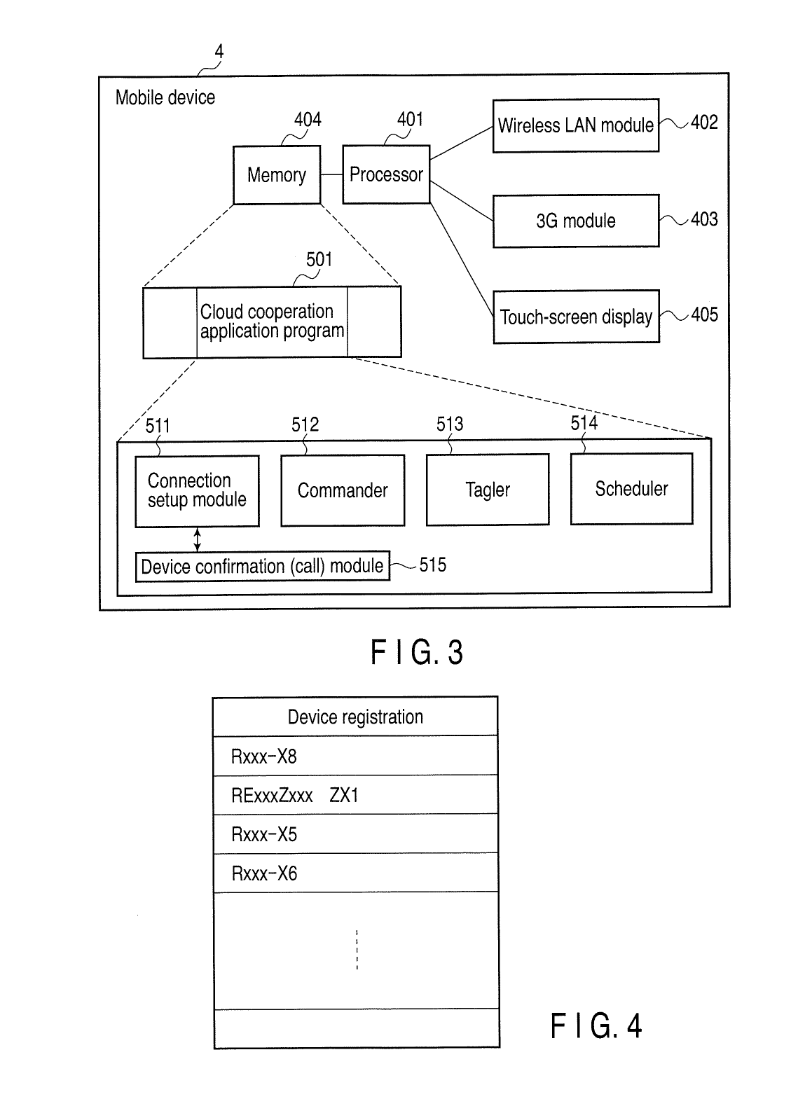

Next, referring to FIG. 3, a description is given of a structure example of hardware and software of the mobile device 4.

The device 4 comprises a processor (CPU) 401, a wireless LAN module 402, a 3G module 403 for mobile communication, a memory 404 and a touch-screen display 405. The memory 404 stores various programs which are executed by the processor 401. These programs include an application program (cloud cooperation application program) 501 for causing the mobile device 4 to function as an IP remote-controller comprising the above-described identification process function. The functions of the connected device list acquisition module 41, selected device determination module 44, transmission instruction determination module 45 and instruction transmitter 47, which have been described with reference to FIG. 1, can all be realized by the cloud cooperation application program 501.

The cloud cooperation application program 501 is software for operating a plurality of kinds of video devices, such as a TV and an HDD recorder, with a unified interface, from the mobile device 4 which is a mobile terminal such as a mobile phone connected to the network 3. With use of the cloud cooperation application program 501, the remote-control operation screen can be displayed on the display (touch-screen display 405) of the mobile device 4, as described above, and the TV/HDD recorder can be remote-controlled, instead of using the infrared/wireless remote-controller attached to the TV/HDD recorder, and the broadcast program can be viewed. Moreover, a playback start position of vide can be searched by using bookmarks (tag list) created by the HDD recorder, etc.

The cloud cooperation application program 501 comprises, for example, a connection setup module 511, a commander 512, a Tagler 513, a scheduler 514 and a device confirmation (call) module 515. The connection setup module 511 searches video devices connected to the network 3 such as a local area network, and executes connection setup for connecting the video devices to the mobile device 4 that is the IP remote-controller.

The connection setup module 511 searches TV/HDD recorders on the local area network and connects them to the IP remote-controller. The connection setup is executed only once, when the use of the cloud cooperation application program 501 is started or when a new IP remote-controller/TV/HDD recorder is connected. In the connection setup, for example, a device registration process is executed for setting, on the IP remote-controller side, information of searched video devices (e.g. device names, user name, password, port number, etc.). In the device registration process, a device list (device registration screen) as shown in FIG. 4 is displayed. A list of device names of searched video devices is displayed on the device list (device registration screen). In each video device, the device name, user name, password, port number, etc. are preset. By using the remote-controller attached to each video device, for example, the user can set the device name, user name, password, port number, etc. in each video device. A default device name may be preset in each video device. For example, the same user name, password and port number as the user name, password and port number set in the video device may be registered in the mobile device 4, thereby enabling the remote-control of the video device.

The device confirmation (call) module 515 executes the above-described device identification process. Specifically, when an identification-target video device has been selected by the user from the list (device name list) of video devices displayed on the display of the mobile device 4, for example, the device confirmation (call) module 515 transmits a device conformation operation command to the identification-target video device via the network 3.

The device identification process, which is executed by the device confirmation (call) module 515, may be executed, for example, when the device registration process (connection setup) is executed. In this case, for example, when a certain device name in the device list shown in FIG. 4 is pressed by the user for a long time, the device confirmation (call) module 515 may determine that the device corresponding to the device name has been selected as the identification-target device, and may transmit the device confirmation operation command to this device.

The commander 512 executes a channel change or volume change by remote-controlling each video device. The commander 512 displays, on the display of the mobile device 4, a remote-control operation screen corresponding to the kind of the operation-target video device which has been selected by the user from the list of video devices displayed on the display of the mobile device 4. When one of buttons displayed on the remote-control operation screen has been selected by the user, the commander 512 transmits a command corresponding to the selected button to the operation-target video device via the network 3. The Tagler 513 executes a playback start point search of video in accordance with a tag list downloaded from a dedicated server on the Internet. The scheduler 514 executes a process for executing programmed recording, by mail or from the IP remote-controller.

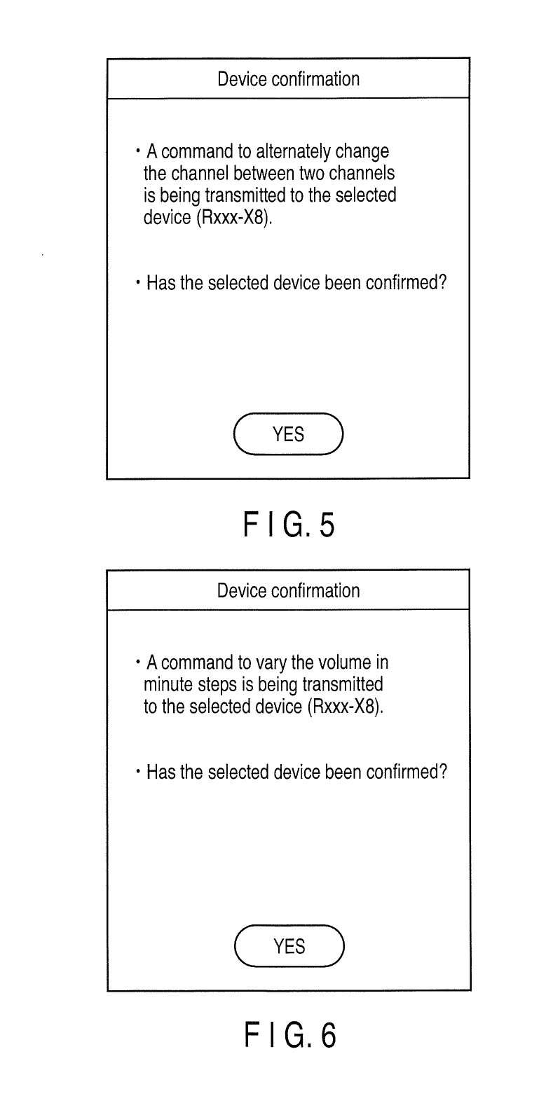

FIG. 5 shows an example of a device confirmation screen which is displayed on the display (touch-screen display 405) of the mobile device 4 in the device identification process.

In the device confirmation process, a device confirmation operation command using an existing command is transmitted to the selected identification-target video device. It is preferable, therefore, to notify the user, in advance, what change is caused in the operation of the video device by the device confirmation operation command. Thus, when commands to alternately change the channel (e.g. a channel-number-up command, and a channel-number-down command) are used as the device confirmation operation command, it is possible to display, on the device confirmation screen, a message for notifying the user what change of the operation occurs in the video device, for example, a message, as shown in FIG. 5, which reads “A command to alternately change the channel between two channels is being transmitted to the selected device (Rxxx-X8)”. The device confirmation screen shown in FIG. 5 may further display a message “Has the selected device been confirmed?”, and a “YES” button. The “YES” button corresponds to the above-described “confirmation” button for notifying the completion of confirmation. The commands for alternately changing the channel are repeatedly transmitted until the “YES” button is pressed by the user.

When commands for varying the sound volume in minute steps (e.g. a volume-up command, and a volume-down command) are used as the device confirmation operation command, it is possible to display, on the device confirmation screen, a message for notifying the user what change of the operation occurs in the video device, for example, a message, as shown in FIG. 6, which reads “A command to vary the volume in minute steps is being transmitted to the selected device (Rxxx-X8)”.

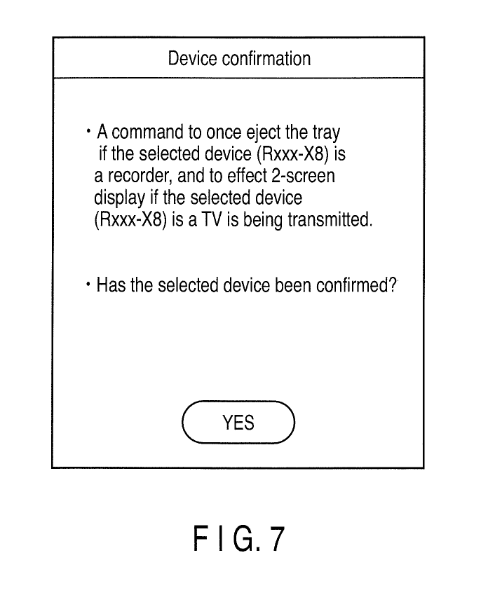

When commands in which a command for 2-screen display and a command for unloading recording media are combined is used as the device confirmation operation command, it is possible to display, on the device confirmation screen, a message for notifying the user what change of the operation occurs in the video device, for example, a message, as shown in FIG. 7, which reads “A command to once eject the tray if the selected device (Rxxx-X8) is a recorder, and to effect 2-screen display if the selected device (Rxxx-X8) is a TV is being transmitted.”

As has been described above, according to the present embodiment, the user is enabled to easily confirm which device in the home an operation-target device corresponds to, before the operation-target device is actually remote-controlled or before a device registration process of the operation-target device is executed. It is possible, therefore, to smoothly perform such an operation as to select an operation-target video device from a list of searched video devices on the network, and to easily remote-control the video devices on the network from a single mobile device.

Since the device identification process can also be executed at an arbitrary timing by an explicit instruction by the user, the user may start the device identification process, where necessary. Thereby, the user can easily confirm, when necessary, which device a device name displayed on the screen of the mobile device corresponds to.

Since the remote-control process of the embodiment including the device identification process can all be realized by a computer program, the same advantageous effects as with the present embodiment can easily be obtained simply by installing the computer program into a computer (a mobile phone, a PDA, a personal computer, etc.) and executing the computer program.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. An electronic device comprising:
a device search module configured to search video devices connected to a network;
a first command transmitting module configured to transmit a predetermined command group to an identification-target video device via the network in order to make a user confirm the identification-target video device, the identification-target video device being selected by the user from the searched video devices, the predetermined command group being pre-selected from commands for controlling an operational environment relating to a video process, the predetermined command group comprising a plurality of unique commands corresponding to a plurality of predetermined video devices, the plurality of unique commands comprising at least one unique command for each of the plurality of predetermined video devices; and
a second command transmitting module configured to transmit a command to an operation-target video device via the network in order to remote-control the operation-target video device, the operation-target video device being selected by the user from the searched video devices, the command causing the operation-target video device to execute an operation designated by the user.

2. (canceled)

3. (canceled)

4. (canceled)

5. The electronic device of claim 1, wherein the predetermined command group comprises at least one of a command to alternately change a channel, a command to alternately change input video, a command to vary a sound volume, a command to execute multi-screen display and a command to unload recording media.

6. The electronic device of claim 1, further comprising a display module configured to display a list of the searched video devices on a display of the electronic device,
wherein the first command transmitting module is configured to transmit the predetermined command group to the identification-target video device via the network, when the identification-target video device is selected by the user from the list of the searched video devices displayed on the display; and
the second command transmitting module is configured to display on the display a remote-control operation screen corresponding to the operation-target video device selected by the user from the list of the searched video devices displayed on the display, and to transmit a command corresponding to a selected button to the operation-target video device via the network when one of buttons displayed on the remote-control operation screen is selected by the user.

7. (canceled)

8. (canceled)

9. A non-transitory computer readable medium having stored thereon a program for causing a computer connected to a network to remote-control a video device on the network, the program causing the computer to:
search video devices connected to the network;
transmit a predetermined command group to an identification-target video device via the network, when a user selects the identification-target video device from the searched video devices, the predetermined command group being pre-selected from commands for controlling an operational environment relating to a video process, the predetermined command group comprising a plurality of unique commands corresponding to a plurality of predetermined video devices, the plurality of unique commands comprising at least one unique command for each of the plurality of predetermined video devices; and
transmit a command to an operation-target video device via the network when the user selects the operation-target video device from the searched video devices, the command causing the operation-target video device to execute an operation designated by the user.

10. (canceled)

11. An electronic device comprising:
a device search module configured to search video devices connected to a network; and
a first command transmitting module configured to transmit a predetermined command group to at least one selected from the video devices searched by the device search module, the predetermined command group comprising a plurality of unique commands corresponding to a plurality of video devices, the plurality of unique commands comprising at least one unique command for each of the plurality of video devices.

12. The electronic device of claim 11, further comprising a second command transmitting module configured to transmit a command to an operation-target video device via the network, the operation-target video device being selected by the user from the searched video devices, the command causing the operation-target video device to execute an operation designated by the user.

13. The electronic device of claim 11, wherein the predetermined command group comprises at least one of a command to alternately change a channel, a command to alternately change input video, a command to vary a sound volume, a command to execute multi-screen display and a command to unload recording media.

14. The electronic device of claim 12, wherein the predetermined command group comprises at least one of a command to alternately change a channel, a command to alternately change input video, a command to vary a sound volume, a command to execute multi-screen display and a command to unload recording media.

15. A non-transitory computer readable medium having stored thereon a program for causing a computer connected to a network to remote-control a video device on the network, the program causing the computer to:
search video devices connected to a network; and
transmit a predetermined command group to at least one selected from the searched video devices, the predetermined command group comprising a plurality of unique commands corresponding to a plurality of video devices, the plurality of unique commands comprising at least one unique command for each of the plurality of video devices.

16. The non-transitory computer readable medium of claim 15, wherein the program further causes the computer to transmit a command to an operation-target video device via the network, the operation-target video device being selected by the user from the searched video devices, the command causing the operation-target video device to execute an operation designated by the user.
